(19) United States
(12) Patent Application Publication
(10) Pub. No.: US 2003/0107244 A1
(43) Pub. Date: Jun. 12, 2003

(54) Panel sealing structure

(75) Inventors: Michio Tamura, Saitama (JP); Masaharu Ohnishi, Saitama (JP); Tatsuya Ohara, Saitama (JP); Tatsuaki Uehara, Tochigi (JP); Yoshitaka Higuchi, Tochigi (JP)

Correspondence Address: SUGHRUE MION, PLLC, 2100 Pennsylvania Avenue, NW, Washington, DC, 20037-3213, US

(73) Assignees: YACHIYO KOGYO KABUSHIKI KAISHA; HONDA GIKEN KOGYO KABUSHIKI KAISHA

(21) Appl. No.: 10/247,823

(22) Filed: Sep. 20, 2002

(30) Foreign Application Priority Data
Sep. 21, 2001 (JP) P.2001-288003

(51) Int. Cl. B60J 10/12

(52) U.S. Cl. 296/216.09

(57) ABSTRACT

The present invention provides a panel seal structure having a seal mounted around the outer circumferential edge of a panel body, such as glass panel, covering an opening formed in a vehicle body. An upper face of the seal is set to be substantially flush with an upper face of the panel body. A lip to be contactable with an edge of the panel body is formed along the upper face of the seal, and the edge of the lip is deformed downward upon contact with the edge of the panel body. Thereby, since the edge of the lip is deformed downward, a dimensional error of the panel body is accommodated for, and the continuity between the upper face of the seal and the upper face of the panel body is enhanced.

### BACKGROUND OF THE INVENTION

The present invention relates to a panel seal structure including a seal mounted around a circumferential edge of a panel for use in covering an opening formed in a vehicle body.

Sunroofs in vehicles are well known and typically include a stationary roof panel and a movable panel. The stationary roof panel of the vehicle body is formed with an opening. The movable panel has a plate glass or a steel plate that is provided slidably in the longitudinal direction of the vehicle to open or close the opening. This type of sunroof also has a seal member for preventing rainwater from entering into the vehicle by closely placing the seal member in contact with an inner circumferential edge of the opening. In one related art application, the seal member is mounted around an outer circumferential edge of the panel body (refer to JP-A-8-113040).

In many applications, however, it is desirable to use a so-called flush surface structure in which the upper surface of the seal member, the upper surface of the movable panel, and the upper surface of the stationary roof panel of the vehicle body are flush and continuous with one another. This flush surface structure is used to suppress wind noise when the movable panel is in a closed position, and also has the added benefit of making the vehicle look more attractive.

To realize this flush surface structure, a structure has been already employed for some commercially available vehicles in which a synthetic resin frame having the junctions of the seal member is injection molded around the outer circumferential edge of the panel body (refer to JP-A-6-191280).

With this related art structure, however, the synthetic resin frame must be outsert molded onto the panel body. Therefore, when using this method, there is a very narrow range for absorbing manufacturing errors of the panel body. As such, because of the necessity of precision manufacturing of the panel body, the manufacturing process becomes complex and manufacturing costs are increased.

### SUMMARY OF THE INVENTION

The present invention solves the aforementioned problems associated with the related art, and it is an object of the invention to provide an improved flush surface panel sealing structure that does not require as precise of manufacturing process for the panel body as in the related art.

In order to accomplish the above object, the present invention provides a panel seal structure having a seal 12 mounted around the outer circumferential edge of a panel body (glass panel 5 in an embodiment) covering an opening 2 formed in a vehicle body. The panel seal structure of the present invention is characterized in that an upper face of the seal 12 is set to be substantially flush with an upper face of the panel body, a lip 20 to be contactable with an edge of the panel body is formed along the upper face of the seal, and the edge of the lip is deformed downward upon contact with the edge of the panel body.

With this panel seal structure, the edge of the lip is deformed downward to absorb a dimensional error of the panel body, and enhance the continuity between the upper face of the seal and the upper face of the panel body.

### BRIEF DESCRIPTION OF THE DRAWINGS

FIG. 1 is a perspective view of a vehicle roof having a sunroof to which the panel sealing structure of the present invention is applied; and

FIG. 2 is an enlarged cross-sectional view of a seal member according to the invention.

### DETAILED DESCRIPTION OF THE PREFERRED EMBODIMENTS

The preferred embodiments of the present invention will be described below with reference to the accompanying drawings.

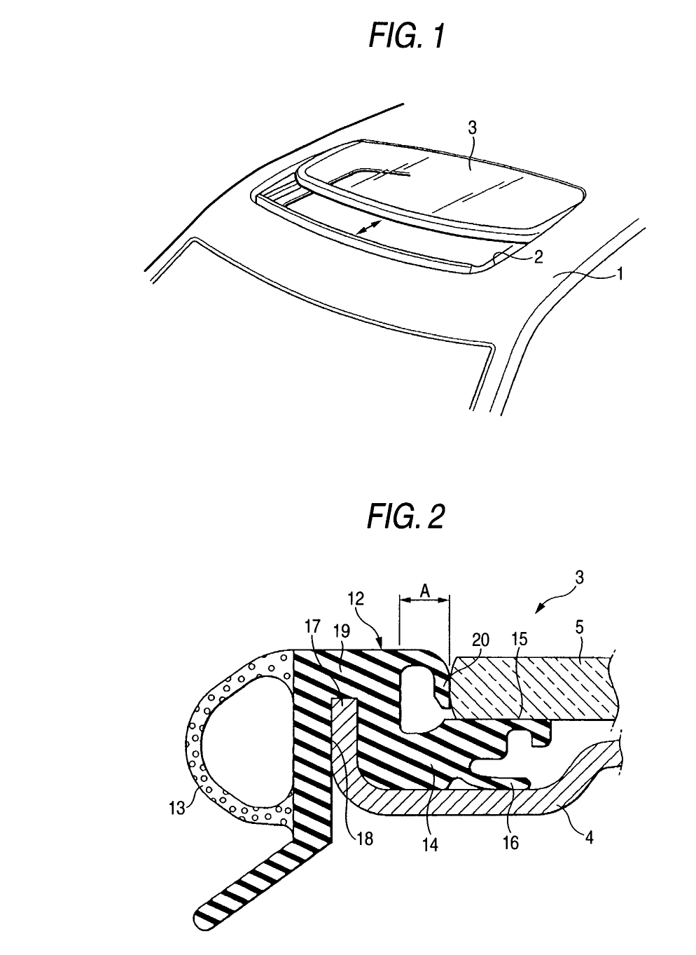

FIG. 1 is a perspective view of a vehicle roof having a sunroof to which the panel sealing structure of the present invention is applied. As shown in FIG. 1, a stationary roof 1 of the vehicle is formed with a slightly laterally elongated rectangular opening 2. The opening 2 can be opened or closed by a movable panel 3 shaped to correspond with the inner circumferential contour of the opening 2.

As shown in FIG. 2, the movable panel 3 is composed of a glass holder 4 and a glass panel 5 as a panel body fixed on the glass holder 4 by, for example, adhesives. The glass holder 4 is formed from a metal plate, and connected to a slide shoe that slides along a guide rail (not shown) provided on the side of the stationary roof and a cam or link mechanism for effecting a tilt operation or slide operation.

A seal member 12 is mounted around the outer circumferential edge of the glass panel 5 in order to prevent rainwater from entering into a vehicle compartment while the seal member is in close contact with the inner circumferential edge of the opening 2; or in more common terms, when the sunroof is closed. The seal member 12 has an opening contact portion 13 that is made of a soft material configured in a hollow shape so as to be relatively easily collapsible. The seal member 12 also has a glass panel connecting portion 14 that is made of a hard material and that is solid-shaped. The seal member 12 may be formed, for example, by extrusion molding the synthetic resin material into a long member having a uniform cross section.

The glass panel connecting portion 14 comprises a shelf portion 15, a camber absorption lip 16, a glass holder connecting portion 19, and a panel edge contact lip 20. The shelf portion 15 makes contact with a lower face of the glass panel 5. The camber absorption lip 16 is formed on a lower face of the shelf portion 15 to follow the curvature of the glass holder 4 by resiliently contacting with an upper face of the glass holder 4 curved in accordance with the curvature of the outer face of the stationary roof 1. The glass holder connecting portion 19 is set up to be substantially flush with the upper face of the glass panel 5 laid on the upper face of the shelf portion 15. The glass holder connecting portion 19 has a groove 18 for carrying a rising edge 17 formed on the outer circumferential edge of the glass holder 4. The panel edge contact lip 20 extends from the upper face of the glass holder connecting portion 19.

Between the glass holder connecting portion 19 and the outer circumferential edge of the glass panel 5, a gap A is appropriately provided to allow for trouble-free mounting of the seal member 12, even if there is an error in the outer dimension of the glass panel 5. To explain, the panel edge contact lip 20, upon making contact with the outer circumferential edge of the glass panel 5, is deformed downwards to enter its edge into the gap A. With the amount of deflection at this time, the panel edge contact lip 20 can accommodate for the error in the outer dimension of the glass panel 5. That is, when the error of the glass panel 5 is in the plus direction, the panel edge contact lip 20 is flexed downwards to increase the amount of the edge entering into the gap A. In contrast, when the error of the glass panel 5 is in the minus direction, the panel edge contact lip 20 tends to extend to decrease the amount of the edge entering into the gap A.

As described above, the edge of the lip is deformed downward upon contact with the edge of the panel body to absorb a dimensional error of the panel body, and enhance the continuity between the upper face of the seal and the upper face of the panel body. Accordingly, a flush surface structure can be realized without greatly changing the related art seal structure. As a result, the appearance of the vehicle is enhanced and wind noise is reduced, without increasing manufacturing complexity or costs, or degrading the waterproof performance of the flush surface structure.

The present invention is not limited to the specific above-described embodiments. It is contemplated that numerous modifications may be made to the present invention without departing from the spirit and scope of the invention as defined in the claims. For example, while the sealing structure is described for use in a sunroof application of a vehicle, it may be employed in other applications where openings in structure are required to be sealed and water or air tight.

What is claimed is:

1. A panel sealing structure comprising:
a panel body covering an opening formed in a structure; and
a seal mounted around an outer circumferential edge of the panel body, the seal including:
an upper face set to be substantially flush with an upper face of the panel body; and
a lip formed along the upper face of the seal, at least a portion of the lip to be contactable with an edge of the panel body, and operable to deform downward upon contact with the edge of the panel body.

2. The panel sealing structure according to claim 1, wherein the panel body is a glass panel.

3. The panel sealing structure according to claim 1, wherein the structure is a vehicle body.

4. A panel sealing structure comprising:
a panel body covering an opening formed in a structure; and
a seal mounted around an outer circumferential edge of the panel body, the seal including:
a gap; and
a lip, at least a portion of the lip to be contactable with an edge of the panel body, and operable to deform downward into the gap upon contact with the edge of the panel body.
